(19) United States
(12) Patent Application Publication
(10) Pub. No.: US 2008/0168780 A1
(43) Pub. Date: Jul. 17, 2008

(54) System And Method For Operating An Electrical System

(76) Inventors: Thomas Sauer, Idstein (DE); Thomas Betz, Igersheim (DE); Andreas Fessel, Schwabisch Hall (DE)

Correspondence Address: BRINKS HOFER GILSON & LIONE, P.O. BOX 10395, CHICAGO, IL, 60610, US

(21) Appl. No.: 11/791,265

(22) PCT Filed: Oct. 26, 2005
(86) PCT No.: PCT/EP2005/055579

§ 371 Date: Oct. 9, 2007

(30) Foreign Application Priority Data
Nov. 19, 2004 (EP) 04105928.8

(51) Int. Cl. F24F 3/16; G05B 19/042; G06K 9/18

(52) U.S. Cl. 62/78; 700/277; 235/462.01

(57) ABSTRACT

A system and method for operating an electrical system includes a functional unit having an optical, electromagnetic and/or mechanical identification label of a network address which can be read from the outside.

The invention relates to a method for commissioning an electrical system, in particular a ventilation system, comprising electromechanical functional units which are arranged in a physically distributed manner in specific installation positions and are individually controlled by a central control unit via a signal transmission network by means of a (network) address which is stored in electronic form.

The invention also relates to a functional unit for use in this method.

An arrangement of this type can be found, for example, in clean room systems and is presented in EP 0 743 578 B1. This document describes the bidirectional communication between the respective functional units, that is to say filter/ventilator units, and the central control unit on the basis of an LON network (Local Operating Network). This network, which is known from and is standard in building automation and industrial automation, makes it possible for the central control unit to individually control each filter/ventilator unit in accordance with the ventilation requirements of a clean room on the basis of status and control information. In this case, the central control unit is, as a rule, a personal computer or quite generally a computer control means. The ventilation system which is made up of the individual filter/ventilator units is graphically displayed on the screen of the monitor of the control means. This provides an overview of the system and each ventilator can be accessed and its settings changed by the PC in a targeted manner using corresponding control instructions. In addition, a defective filter/ventilator unit can be displayed on the screen in the event of a fault and, if necessary, each faulty filter/ventilator unit can be acted on easily and quickly in a targeted manner on account of the graphical display which is matched to the locality.

The problem of assigning the address or the identification number of the filter/ventilator units to the physical position of said filter/ventilator units arises during installation and commissioning of the system.

EP 0 743 578 B1 does not address this problem of assignment between identification number and installation position, but instead assumes that an unambiguous address or identification number, which is stored in the memory (EEPROM) of a microcontroller, is assigned to the filter/ventilator units during the production process of said filter/ventilator units.

During installation and commissioning of the system, it is no longer possible to assume that the ventilators are fitted at the installation location in the order which corresponds to the address number. Installation is carried out randomly, it being possible, as already mentioned above, for the ceiling of a clean room to have several hundred or several thousand ventilators of the same type which are, for example, arranged in a rectangular matrix.

However, in order to be able to address each ventilator in a targeted manner, the assignment of the address or identification number (identifier) to the physical position of said ventilator in the XY matrix must be known. Since the ventilator is usually addressed by means of visualization software which shows the physical arrangement of the ventilators on the screen of a PC, the address or identification number of the ventilator must be assigned to the symbol of the ventilator on the screen in the visualization software.

The object of the present invention is to develop a method which ensures simple, quick and also reliable assignment of identification number to installation position for each functional unit. A further intention is to be able to design functional units for use in this method, the features of said functional units supporting this objective.

According to the invention, this is achieved in that each functional unit is provided with a first optical, electromagnetic and/or mechanical identification label which can be read from the outside and can be unambiguously assigned to the device-specific internal address, and with a second optical, electromagnetic and/or mechanical auxiliary label which can be read from the outside and contains specific information, and in that the two labels are, as a pair, detected using an optical, electromagnetic and/or mechanical reading means and electronically stored and transmitted to the control unit for further processing.

The object is also achieved by functional units with machine-readable labeling of the identification number. The functional units are linked, such that telecommunication is possible, by means of a signal transmission network which can be designed, for example, as a bus system, as a bus system with serial data transmission, as a bus system with a TCP/IP transmission protocol or as an LON network.

The use of the method according to the invention is explained using the example of the above-described ventilation system in a clean room. In this exemplary embodiment, the functional units represent filter/ventilator assemblies, with the identification label corresponding to unambiguous mapping of the programmed (network) address and the auxiliary label indicating the installation position, possibly by means of a mapping rule. The two labels which can be read from the outside are preferably designed as barcodes. Telecommunications transmission systems which are based on electromagnetic methods, for example novel RFID applications, are feasible in addition to this optical memory and transmission method. During production of the filter/ventilator units, an address is definitively allocated to each unit on a continuous basis, it being possible for this to be performed, for example, in a microcontroller with a memory (EEPROM). This microcontroller is preferably a constituent part of the motor electronics. The address for each unit is unambiguously defined, that is to say multiple address assignment does not exist. The address can, for example, be written to the memory during final inspection of the device. The address is also additionally printed out by means of a barcode printer and applied as an identification label to the housing of the filter/ventilator unit, which is assigned to the address, in a location which will later be easily accessible. Therefore, after production of the ventilator is complete, each ventilator has its individual address, which is documented by means of the barcode on each ventilator. In addition, the address can also be printed out alphanumerically. The filter/ventilator units are then fitted to the ceiling of the clean room in any desired order irrespective of the address. Following installation, a second barcode is applied to the ventilator housing as an auxiliary label which indicates the installation position of this filter/ventilator unit. These second barcodes are printed before commissioning of the system in accordance with the required position information, for example in coded form in an ascending order. It is also possible to attach an additional alphanumeric position designation, for example for monitoring purposes. After the labels are applied, a mobile barcode scanner reads the barcode for the address and the barcode for the position of the ventilator as a pair from each ventilator. The barcode scanner is usually operated in conjunction with a portable PC which processes and stores the data in an appropriate manner. The result is an association table which is transmitted to the visualization system in electronic form. The address and position are unambiguously assigned in the visualization system in this way.

This method therefore permits fault-free assignment, in addition to simple and quick assignment of address and position, since the association table is generated without potentially faulty manual entry of data. The visualization system also permits all the associations to be quickly monitored.

In order to further explain the invention, reference is made to the drawings relating to the above-described embodiment. In the drawings:

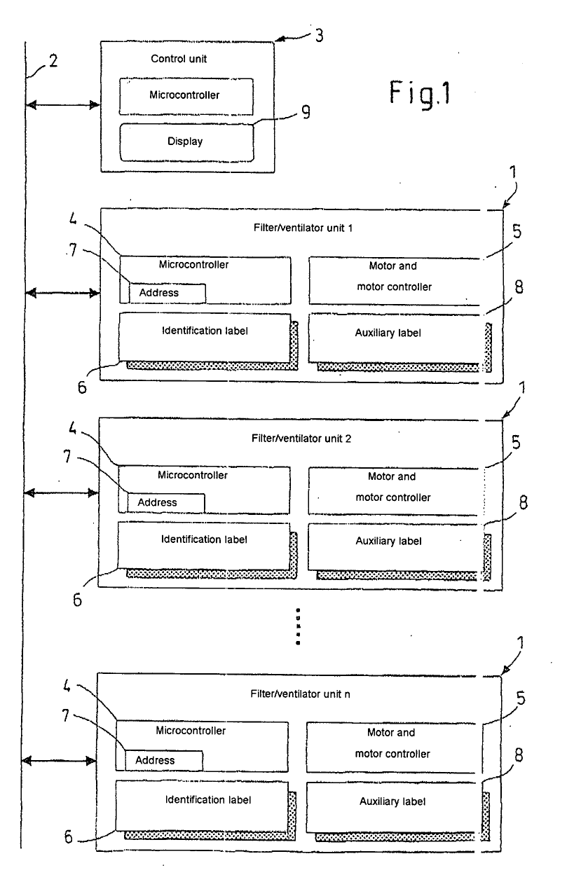

FIG. 1 shows a functional block diagram for signal transmission between the filter/ventilator units and the central control unit via a bus system, and

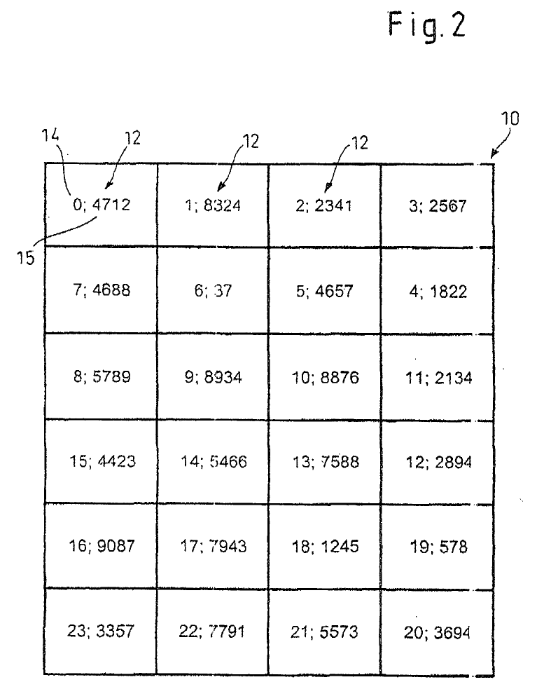

FIG. 2 shows an exemplary embodiment of the visualized association table with numerical coding of the installation position.

The linking by means of signals which is illustrated in the block diagram in FIG. 1 permits the (network) address 7 of each filter/ventilator unit 1 to be individually addressed by the central control unit 3 via the bus system 2. The address 7 was previously permanently stored in the memory of the microcontroller 4 of the respective filter/ventilator unit 1 during the production process of the filter/ventilator unit 1, and is detected by the microcontroller 4 of the addressed filter/ventilator unit 1 when transmitted on the bus system 2, with the result that subsequent control signals are interpreted by this addressed filter/ventilator unit 1 and can act on the motor or the motor controller 5.

The address 7 which is stored in the memory of the microcontroller 4 is additionally applied to the housing of the filter/ventilator unit 1 as a machine-readable identification label 6 (for example a barcode sticker). The installation position of the filter/ventilator unit 1 is also applied as a machine-readable auxiliary label 8 (for example a barcode sticker) in such a way that the two labels 6, 8 are read into the control unit 3, using a suitable separate reading device (for example barcode reader), from outside as a pair and such that they are stored for further processing, and there can be displayed on a display 9.

FIG. 2 shows the association table 10 which, according to the invention, can be graphically displayed on a display 9 after the identification label 6 and the auxiliary label 8 are read and stored as a pair. The matrix-like arrangement of the pairs 12 of labels reflects the physical arrangement of the filter/ventilator units 1 on the ceiling of a clean room, with the first numeral 14 representing a numerically coded representation of the position of the filter/ventilator unit and the second numeral 15 representing the address 7 of the filter/ventilator unit 1.

In addition, the invention is not restricted to the combination of features defined in the claims but can also be defined by any other desired combination of specific features of all the individual features disclosed overall. This means that, in principle, virtually any individual feature of the claims can be omitted or replaced by at least one individual feature which is disclosed at another point in the application.

In this respect, the claims are to be understood merely as a first attempt at formulating an invention.

1. A method for operating an electrical system, the method comprising the steps of:
arranging electromechanical functional units in a physically distributed manner in specific installation positions, wherein each electromechanical functional units are individually controlled by a central control unit via a signal transmission network by way of a network address which is stored in electronic form; providing each electromechanical functional unit with a first optical, electromagnetic and/or mechanical identification label, wherein the first identification label can be read from the outside and is unambiguously assigned to a device-specific address; providing each electromechanical functional unit with a second optical, electromagnetic and/or mechanical auxiliary label which can be read from the outside and contains specific information; and
detecting as a pair the first and second labels using an optical, electromagnetic and/or mechanical reading means, whereby the first and second labels are electronically stored and transmitted to the central control unit for further processing.

2. The method as claimed in claim 1, further comprising the step of applying a barcode to the first label of the device-specific address of the functional unit.

3. The method as claimed in claim 1 further comprising the step of applying a barcode to the second label of the functional unit.

4. The method of claim 1 further comprising the step of graphically displaying the first label and second label on a display in the form of an assignment table.

5. The method as claimed in claim 1 wherein the electromechanical functional units and the control unit are linked via a signal transmission network.

6. The method as claimed in claim 5, wherein the signal transmission network is designed as a bus system.

7. The method as claimed in claim 5, wherein the signal transmission network is in the form of Local Operating Network or a bus system with a TCP/IP transmission protocol.

8. A functional unit comprising an optical, electromagnetic and/or mechanical identification label of the network address which can be read from the outside.

9. The functional unit as claimed in claim 8, further comprising an optical, electromagnetic and/or mechanical auxiliary label which can be read from the outside, particularly in the form of a barcode, which is arranged in such a way that it is possible to read said auxiliary label together with the identification label as a pair.

10. The functional unit as claimed in claim 8 wherein the functional unit is an electromotively operated apparatus.

11. The functional unit as claimed in claim 8 wherein the functional unit is a filter/ventilator unit.
